(19) United States
(12) Patent Application Publication
(10) Pub. No.: US 2026/0008182 A1
(43) Pub. Date: Jan. 8, 2026

(54) ROBOT DIAGNOSTIC SYSTEM

(71) Applicants: Hyundai Motor Company, Seoul (KR); Kia Corporation, Seoul (KR)

(72) Inventors: Hyeong Woon LEE, Hwaseong-Si (KR); Tae Soo KIM, Hwaseong-Si (KR)

(73) Assignees: Hyundai Motor Company, Seoul (KR); Kia Corporation, Seoul (KR)

(21) Appl. No.: 18/955,639

(22) Filed: Nov. 21, 2024

(30) Foreign Application Priority Data
Jul. 2, 2024 (KR) 10-2024-0087162

(51) Int. Cl. B25J 9/16; G01H 1/00

(52) U.S. Cl. CPC B25J 9/1674; G01H 1/00

(57) ABSTRACT

A robot diagnostic system includes a first robot, a second robot configured to simulate driving of the first robot, a model builder configured to learn data on a normal driving state or an abnormal driving state of the first robot or the second robot and build a model that is configured to determine whether the first robot is abnormal, and a diagnostic device configured to receive data on the driving of the first robot and diagnose a state of the first robot through the built mode.

### CROSS REFERENCE TO RELATED APPLICATION

The present application claims priority to Korean Patent Application No. 10-2024-0087162 filed on Jul. 2, 2024, the entire contents of which is incorporated herein for all purposes by this reference.

### BACKGROUND OF THE PRESENT DISCLOSURE

### Field of the Present Disclosure

The present disclosure relates to a robot diagnostic system capable of predicting the occurrence of abnormality in a robot at an early stage.

### Description of Related art

Various pieces of equipment are present in a factory for producing products. Most pieces of equipment may fail due to aging, and it is essential to maintain equipment at an appropriate time to maintain an output of the product.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to checking problematic equipment in a timely manner by predicting the occurrence of abnormality in industrial robots corresponding to production equipment at an early stage, preventing equipment downtime and maintaining an output.

According to an exemplary embodiment of the present disclosure, there is provided a robot diagnostic system, which includes a first robot, a second robot configured to simulate driving of the first robot, a model builder configured to learn data on a normal driving state or an abnormal driving state of the first robot or the second robot and build a model that is configured to determine whether the first robot is abnormal, and a diagnostic device configured to receive data on the driving of the first robot and diagnose a state of the first robot through the built model.

The model builder may collect data according to the driving of the first robot or the second robot, and the data may include vibrations, a current, or a location.

The model builder may collect and learn the data on the normal driving state of the first robot or the second robot.

The model builder may match data sampling points by matching vibration data collected according to the driving of the first robot with vibration data collected according to the driving of the second robot.

The pieces of vibration data of the first robot and the second robot may be matched through a dynamic time warping algorithm.

The model builder may overlap pieces of current data of the first robot and the second robot based on the matched data sampling points of the first robot and the second robot.

In a state that a current data collection cycle of the first robot is longer than a current data collection cycle of the second robot, the model builder may allow the current data of the second robot to overlap the current data of the first robot.

Location data of the first robot may be obtained from location data of the second robot.

The model builder may transform the location data of the second robot into three-dimensional coordinates with a value of 0 and 1 and use the same as the location data of the first robot.

The model builder may match data sampling points by matching the vibration data collected according to the driving of the first robot with the vibration data collected according to the driving of the second robot and use the location data of the second robot as the location data of the first robot based on the matched data sampling points of the first robot and the second robot.

The model builder may learn the data on the normal driving state collected through a conditional generative adversarial net (cGAN) model and amplify the data on the normal driving state.

The model builder may collect and learn the data on the abnormal driving state of the second robot.

The model builder may collect the vibration data, current data, and location data collected through the driving of the second robot.

The model builder may learn the data on the abnormal driving state collected through a conditional generative adversarial net (cGAN) model and amplify the data on the abnormal driving state.

The model builder may build a model that expresses an abnormality probability of the first robot as a value of 0 and 1 through the data on the learned data on the normal driving state or the learned data on the abnormal driving state of the first robot or the second robot.

The number of rotational axes of the first robot and the second robot may be the same.

The first robot and the second robot may be 6-axis robots.

Each rotation axis of the first robot or the second robot may be provided with a plurality of sensors configured for measuring vibrations or a current according to the driving of the first robot or the second robot.

According to an exemplary embodiment of the present disclosure, it is possible to check problematic equipment in a timely manner by predicting the occurrence of abnormality in industrial robots corresponding to production equipment at an early stage, preventing the equipment downtime and maintaining the output of the product.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a robot diagnostic system according to an exemplary embodiment of the present disclosure;

FIG. 2 shows a cGAN operation;

FIG. 3 shows a series of processes of building a model;

FIG. 4 shows a dynamic time warping;

FIG. 5A and FIG. 5B show vibration data according to motion segmentation; and

FIG. 6 shows abnormal data obtained by a second robot.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings, and the same or similar components are denoted by the same reference numerals regardless of the drawing symbols, and overlapping descriptions thereof will be omitted.

In describing the exemplary embodiments included in the specification, when it is determined that a detailed description of a related known technology may obscure the gist of the exemplary embodiments included in the present specification, a detailed description thereof will be omitted. Furthermore, the accompanying drawings are only for easy understanding of the exemplary embodiments included in the specification, and it should be understood that the technical spirit included in the specification is not limited by the accompanying drawings, and all changes, equivalents, or substitutes included in the spirit and technical scope of the present disclosure are included in the accompanying drawings.

Terms including ordinal numbers such as first or second may be used to describe various components, but the components are not limited by the terms. The terms are used only for distinguishing one component from another.

The singular includes the plural unless the context clearly dictates otherwise.

In the specification, it should be understood that the term “comprise” or “have” is intended to specify that a feature, a number, a step, an operation, a component, a portion, or a combination thereof described in the specification is present, but do not preclude the possibility of the presence or addition of one or more other features, numbers, steps, operations, components, parts, or combinations thereof.

A controller may include a communication device for communicating with another controller or a sensor to control a function in charge, a memory for storing an operating system or logic commands and input and output information, and one or more processors for performing determination, calculation, decision, and the like necessary for controlling the function in charge.

The non-transitory computer-readable recording medium includes any type of recording media in which data which may be read by a computer system are stored. Examples of the computer-readable medium include a Hard Disk Drive (HDD), a solid state disk (SSD), a silicon disk drive (SDD), a read only memory (ROM), a random access memory (RAM), a CD-ROM, a magnetic tape, a floppy disk, an optical data storage device, and the like. Therefore, the above detailed description should not be construed as limiting in all respects and should be considered illustrative. The scope of the present disclosure should be determined by reasonable construction of the appended claims, and all changes within the equivalent scope of the present disclosure are included in the scope of the present disclosure.

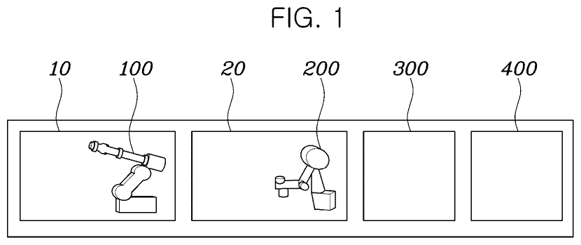

FIG. 1 is a block diagram of a robot diagnostic system according to an exemplary embodiment of the present disclosure. Referring to FIG. 1, a robot diagnostic system according to an exemplary embodiment of the present disclosure includes a first robot 100, a second robot 200 for simulating driving of the first robot 100, a model builder 300 for building a model for learning data on a normal or abnormal driving state of the first robot 100 or the second robot 200 and determining whether the first robot 100 is abnormal, and a diagnostic device 400 for receiving data on the driving of the first robot 100 and diagnosing a state of the first robot 100 through the built model.

The first robot 100 may be production equipment for producing products in a factory 10. The second robot 200 and the first robot 100 may be different robots, and the second robot 200 is a robot made to simulate the driving of the first robot 100. The second robot 200 may be provided in the same space as a laboratory 20.

According to an exemplary embodiment of the present disclosure, by collecting data on a normal or abnormal driving state from the driving of the first robot 100 and the driving of the second robot 200, building the model for learning the collected data and determining whether the first robot 100 is abnormal, and outputting the state of the first robot 100 as a score when the data on the driving of the first robot 100 is input to the built model to diagnose the abnormality of the first robot 100 at an early stage, the first robot 100 may be checked and repaired in a timely manner, preventing a reduction in output of a product.

The present disclosure will be described assuming that the first robot 100 and the second robot 200 are 6-axis robots with 6 degrees of freedom (DoF), but are not limited thereto, and the first robot 100 and the second robot 200 may be robots with less than 6 or more than 6 degrees of freedom.

A driving code may be input to the first robot 100 so that the first robot 100 is configured to perform operations required for producing a product, and the driving code input to the first robot 100 may also be input to the second robot 200, and the second robot 200 may simulate the operation of the first robot 100. The first robot 100 and the second robot 200 may include a controller configured for receiving the driving code.

The first robot 100 and the second robot 200 may include the same number of rotational axes, and each rotation axis may include a built-in motor for moving joints that form the first robot 100 or the second robot 200.

Furthermore, each rotation axis of the first robot 100 or the second robot 200 may be provided with a plurality of sensors embedded in the first robot 100 or the second robot 200 to measure vibrations or a current according to the driving of the first robot 100 or the second robot 200. The plurality of sensors transmit measured data to the model builder 300 so that the model builder 300 may collect data according to the driving of the first robot 100 or the second robot 200.

Here, the plurality of sensors may include a vibration sensor configured for measuring vibrations and a current sensor configured for measuring a current and measure vibrations and a current applied to each rotation axis. A cycle at which the sensors measure the vibrations or the current may vary depending on the specifications of the sensor used. Furthermore, a cycle at which the vibrations or currents of the first robot 100 and the second robot 200 are measured may also vary depending on the specifications of the sensors used.

Meanwhile, the data collected by the model builder 300 may be data including vibrations, a current, or a location according to the driving of the first robot 100 or the second robot 200, and each may refer to a frequency, a current intensity, and location coordinates.

The frequency and current intensity may be measured by the sensor, but in the case of the location, three-dimensional coordinates of each rotation axis forming the second robot 200 may be collected through an offline test of the second robot 200.

The model builder 300 may collect data on the normal or abnormal driving state of the first robot 100 or the second robot 200, and build the model for learning the collected data and determining whether the first robot 100 is abnormal, and the built model may be embedded in the diagnostic device 400.

Here, the normal driving state is a state in which the first robot 100 or the second robot 200 is driven according to the input driving code and there is no load on the rotation axis of the first robot 100 or the second robot 200.

On the other hand, the abnormal driving state means that the second robot 200 is driven according to the input driving code to simulate the driving of the first robot 100, and a torque is artificially applied to a portion of the rotation axis of the second robot 200 (a load such as a weight is applied) or the second robot 200 is driven by a replaced motor with a reduced output.

That is, since the model builder 300 collects and learns data on the normal driving state through the first robot 100 or the second robot 200 but does not need to apply a load to actual production equipment to collect data on the abnormal driving state, the data on the abnormal driving state may be collected through the second robot 200 simulating the driving of the first robot 100.

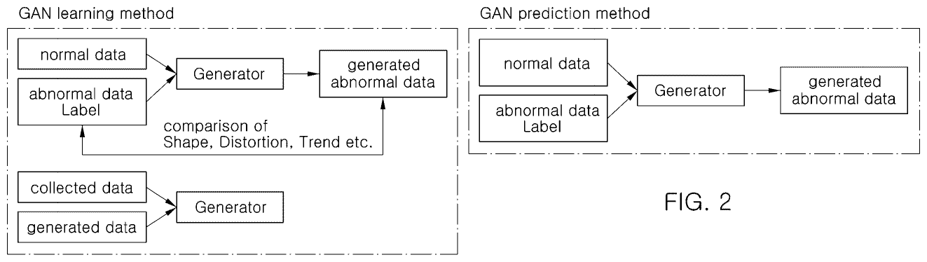

The model builder 300 may collect the data on the normal driving state and the data on the abnormal driving state, and as shown in FIG. 2, the model builder 300 may learn data collected through a conditional generative adversarial net (cGAN) model and generate (amplify) the pieces of data on the normal driving state and the abnormal driving state using the learned model.

The model builder 300 consists of a data collection module and a learning module. The data collection module collects real-time operation data, including sensor data from the first robot or second robot, which may represents both normal and abnormal driving states. The learning module processes the collected data through the cGAN model.

The cGAN is an algorithm configured for generating virtual data using a zero-sum game between two neural network models (generator and discriminator) and may be configured to generate the data on the normal driving state and the data on the abnormal driving state.

When seed data and a case to be generated (a normal driving state or an abnormal driving state) are input into the generator model learning the collected data, virtual data on the corresponding case is output.

Through the series of processes, the model for diagnosing the abnormality in the robot may be built, and the built model may be embedded in the diagnostic device.

The built model is a transformer model (attention-based AI model for time series data processing) and may use two output layers (in the instant case, an input layer and a hidden layer are the same), and the output layers in which a first output layer is configured to determine an abnormality score of the first robot 100 and a second output layer is configured to determine whether to correspond to a normal or abnormal driving state are used to classify cases.

The data input to the transformer model includes a 30-dimensional time series including vibrations (6 dimensions), a current (6 dimensions), and a location (18 dimensions), and when the data of the first robot 100 is input, an abnormality score is determined by the first output layer. The abnormality score includes a value of 0 and 1, and the closer it is to 1, the higher the probability of an abnormal state.

The abnormality score is determined for the detailed operation forming the movement of the first robot 100, and a final abnormality score is determined by summing an abnormality score of each detailed operation.

When the abnormality score is greater than or equal to a preset value, the diagnostic device 400 may be configured to determine that the first robot 100 is in an abnormal state, and thus a manager may perform the examination on the abnormal state of the first robot 100 during an idle time of the first robot 100.

The diagnostic device 400 consists of an abnormality detection module and a state evaluation module. The abnormality detection module continuously monitors the operational data from the first robot 100, comparing real-time data against predefined thresholds to compute the abnormality score. When this score exceeds or equals the preset value, the state evaluation module determines the specific nature of the abnormal state by analyzing the abnormal operation data, providing detailed diagnostic information for the manager. This allows the manager to take appropriate actions, such as performing an examination during the robot's idle time. The diagnostic device 400 may be implemented using hardware components such as sensors and processors, as well as software algorithms that facilitate real-time data analysis and state determination.

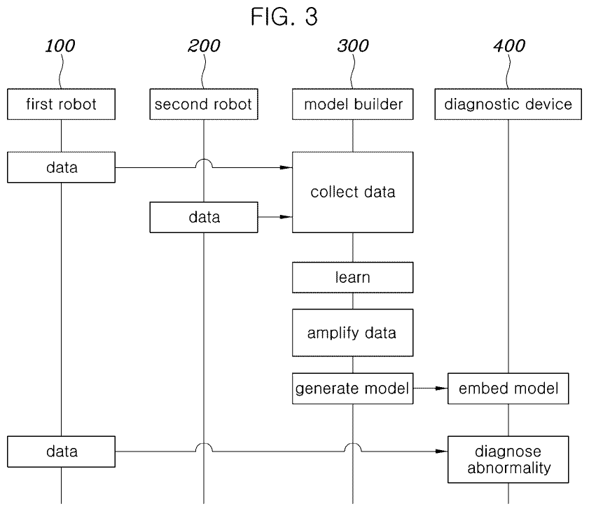

The series of processes is shown in FIG. 3.

Hereinafter, a method of collecting and learning the data on the normal driving state of the first robot 100 or the second robot 200 by the model builder 300 will be described in detail.

In general, the first robot 100 and the second robot 200 are provided with sensors configured for measuring vibrations and a current according to the driving of the robot, but a data collection cycle of each sensor varies depending on the specifications of the sensors.

For example, while the vibration sensor of the first robot 100 may collect data at a cycle of 8000 Hz, the current sensor may collect data at a cycle of 0.2 Hz, and while the vibration sensor of the second robot 200 may collect data at a cycle of 8000 Hz, the current sensor may collect data at a cycle of a 10 Hz. As described above, when the cycles of the sensor at which the pieces of data are collected are different, data cannot be collected based on the same time, resulting in limitations in matching the collected data.

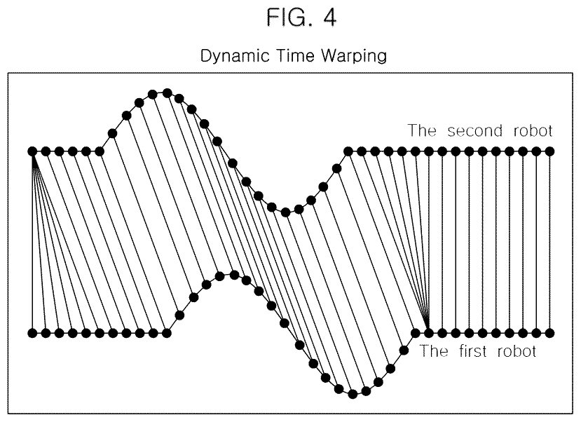

Therefore, for the collection of accurate data, matching of data sampling points is required between collected data with time gaps. The model builder 300 may match data sampling points by matching the vibration data collected according to the driving of the first robot 100 with the vibration data collected according to the driving of the second robot 200. FIG. 4 shows matching the vibration data collected according to the driving of the first robot and the second robot.

The vibration data of the first robot 100 and the second robot 200 may be matched through a dynamic time warping algorithm, and even when the data collection cycles of the first robot 100 and the second robot 200 are different, data sampling points may be matched, as shown in FIG. 4, using the dynamic time warping algorithm.

Dots connected by line segments refer to matched data.

However, when the data on the normal driving state is collected, it is preferable to match the data collection cycles of the vibrations, current, and location of the second robot 200. It is preferable to use the shortest data collection cycle among the vibrations and current of the first robot 100.

For example, as described above, when the vibration sensor of the first robot 100 collects data at a cycle of 8000 Hz, all data on the vibrations, current, and location of the second robot 200 are collected at a cycle of 8000 Hz.

Meanwhile, before matching the vibration data of the first robot 100 with the vibration data of the second robot 200, the model builder 300 removes noise of the vibration data. Band filtering is applied to remove noise, and white noise may be removed using a random matrix.

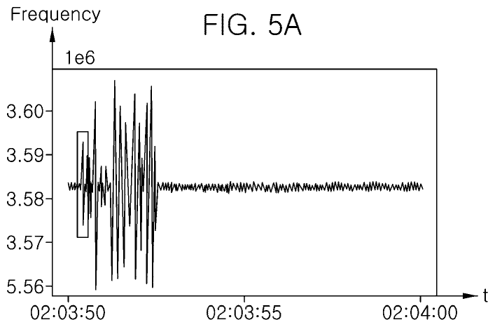

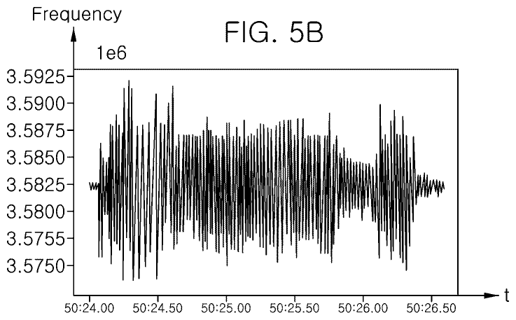

After the noise is removed, the operations of the first robot 100 and the second robot 200 are segmented as shown in FIGS. 5A and 5B. The first robot 100 and the second robot 200, which operate according to the driving code, perform various operations. Therefore, after the entire operation is segmented into detailed operations through Time-Series Segmentation, the vibration data may be transformed into a range of 0 and 1 by applying Min-Max Scaling, and then, as shown in FIG. 4, the pieces of vibration data of the first robot 100 and the second robot 200 may be matched.

The reason why the vibration data is transformed into a range of 0 and 1 by applying Min-Max Scaling is because there is a scale difference in vibration data due to a difference in specifications of the first robot 100 and the second robot 200.

After matching the data sampling points through the pieces of vibration data of the first robot 100 and the second robot 200, based on the same, the model builder 300 may overlap the pieces of current data of the first robot 100 and the second robot 200.

When the current data collection cycle of the first robot 100 is longer than the current data collection cycle of the second robot 200, the model builder 300 may allow the current data of the second robot 200 to overlap the current data of the first robot 100. For example, as described above, when the current sensor of the first robot 100 collects at a cycle of 0.2 Hz, the current data is not sufficient compared to the current sensor of the second robot 200 for collecting data at a cycle of 8000 Hz, and thus the current data measured by the current sensor of the second robot 200 may overlap the current data measured by the current sensor of the first robot 100.

However, before overlapping the pieces of current data, since the first robot 100 and the second robot 200 are not the same and thus there is a scale difference in current intensity, after the current data is transformed into a range of 0 and 1 by Min-Max Scaling, the pieces of current data may overlap each other.

Meanwhile, the location data of the first robot 100 may be obtained from the location data of the second robot 200. That is, since data on the location coordinates of the rotation axis according to the driving of the first robot 100 is not measured, the location data of the second robot 200 is used as the location data of the first robot 100.

Like the vibrations and current, since the first robot 100 and the second robot 200 are not the same, the model builder 300 may transform the location data of the second robot 200 into three-dimensional coordinates with a value of 0 and 1 and use the same as the location data of the first robot 100.

When the location data is three-dimensional coordinates with a value of 0 and 1, it means that in the (x,y,z) coordinate system, x, y, and z all include a value of 0 and 1.

Since the model builder 300 has previously matched the data sampling points through the pieces of vibration data of the first robot 100 and the second robot 200, based on the same, the location data of the second robot 200 may be used as the location data of the first robot 100, and thus the data on the vibrations, current, and location of the normal driving state is obtained.

As described above, the model builder 300 may learn the data on the normal driving state collected through the cGAN model and amplify the data on the normal driving state.

Hereinafter, a method of collecting and learning the data on the abnormal driving state of the second robot 200 will be described in detail.

As described above, the abnormal driving state means that the second robot 200 is driven according to the input driving code to simulate the driving of the first robot 100, and a torque is artificially provided to a portion of the rotation axis of the second robot 200 (a load such as a weight is applied) or the second robot 200 is driven by a replaced motor with a reduced output.

To collect the data on the abnormal driving state, an example in which a torque is artificially applied to a portion of the rotation axis of the second robot 200 will be described.

The second robot 200 may include a total of 6 rotational axes, and a torque may be artificially applied by attaching a weight to each rotation axis. A light weight (weak torque) may be attached to the first, second, third, fourth, fifth and sixth axes to artificially apply a weak torque, and a heavy weight (strong torque) may be attached to artificially apply a strong torque.

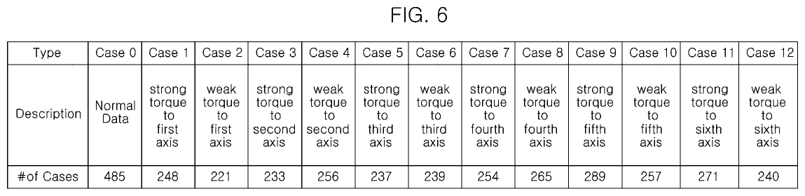

Data in an abnormal driving state may be collected by attaching a weight to some rotational axes to apply an artificial torque and then driving the second robot 200. That is, when the second robot 200 to which the artificial torque is applied is driven, the model builder 300 may collect vibration data, current data, and location data that are different from those of the normal driving state as shown in FIG. 6.

Furthermore, like amplifying the data on the normal driving state, the model builder 300 may learn the data on the abnormal driving state collected through the cGAN model and amplify the data on the abnormal driving state.

The model builder 300 may build a model that expresses the abnormality probability of the first robot as a value of 0 and 1, as described above, through the learned data on the normal driving state or the data on the abnormal driving state of the first robot 100 or second robot 200, and the corresponding model is embedded in the diagnostic device 400.

As described above, the built model is a transformer model (attention-based AI model for time series data processing) and may use two output layers (in the instant case, an input layer and a hidden layer are the same), and the output layers in which a first output layer is configured to determine an abnormality score of the first and a second output layer is configured to determine whether to correspond to a normal or abnormal driving state are used to classify cases.

The data input to the transformer model includes a 30-dimensional time series including vibrations (6 dimensions), a current (6 dimensions), and a location (18 dimensions), and when the data is input, an abnormality score is determined by the first output layer.

The abnormality score includes a value of 0 and 1, and the closer it is to 1, the higher the probability of an abnormal state. The abnormality score is determined for the detailed operation forming the movement of the first robot 100, and a final abnormality score is determined by summing an abnormality score of each detailed operation. When the abnormality score is greater than or equal to the preset value, the diagnostic device may be configured to determine that the first robot is in an abnormal state, and thus a manager may perform the examination on the abnormal state of the first robot during an idle time of the first robot.

Herein, in an exemplary embodiment of the present disclosure, the memory and the processor may be implemented as separate semiconductor circuits. Alternatively, the memory and the processor may be implemented as a single integrated semiconductor circuit. The processor may embody one or more processor(s).

The control device may be at least one microprocessor operated by a predetermined program which may include a series of commands for carrying out the method included in the aforementioned various exemplary embodiments of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A robot diagnostic system comprising:
a first robot;
a second robot configured to simulate driving of the first robot;
a model builder configured to learn data on a normal driving state or an abnormal driving state of the first robot or the second robot and build a model that is configured to determine whether the first robot is abnormal; and
a diagnostic device configured to receive data on the driving of the first robot and diagnose a state of the first robot through the built model.

2. The robot diagnostic system of claim 1, wherein the model builder collects data according to the driving of the first robot or the second robot, and the data includes vibrations, a current, or a location.

3. The robot diagnostic system of claim 1, wherein the model builder collects and learns the data on the normal driving state of the first robot or the second robot.

4. The robot diagnostic system of claim 3, wherein the model builder matches data sampling points by matching vibration data collected according to the driving of the first robot with vibration data collected according to the driving of the second robot.

5. The robot diagnostic system of claim 4, wherein pieces of the vibration data of the first robot and the second robot are matched through a dynamic time warping algorithm.

6. The robot diagnostic system of claim 4, wherein the model builder overlaps pieces of current data of the first robot and the second robot based on the matched data sampling points of the first robot and the second robot.

7. The robot diagnostic system of claim 6, wherein, in a state that a current data collection cycle of the first robot is longer than a current data collection cycle of the second robot, the model builder allows the current data of the second robot to overlap the current data of the first robot.

8. The robot diagnostic system of claim 3, wherein location data of the first robot is obtained from location data of the second robot.

9. The robot diagnostic system of claim 8, wherein the model builder transforms the location data of the second robot into three-dimensional coordinates with a value of 0 and 1 and utilizes the same as the location data of the first robot.

10. The robot diagnostic system of claim 8, wherein the model builder matches data sampling points by matching vibration data collected according to the driving of the first robot with vibration data collected according to the driving of the second robot and utilizes the location data of the second robot as the location data of the first robot based on the matched data sampling points of the first robot and the second robot.

11. The robot diagnostic system of claim 3, wherein the model builder learns the data on the normal driving state collected through a conditional generative adversarial net (cGAN) model and amplifies the data on the normal driving state.

12. The robot diagnostic system of claim 1, wherein the model builder collects and learns the data on the abnormal driving state of the second robot.

13. The robot diagnostic system of claim 12, wherein the model builder collects vibration data, current data, and location data collected through the driving of the second robot.

14. The robot diagnostic system of claim 12, wherein the model builder learns the data on the abnormal driving state collected through a conditional generative adversarial net (cGAN) model and amplifies the data on the abnormal driving state.

15. The robot diagnostic system of claim 1, wherein the model builder builds a model that expresses an abnormality probability of the first robot as a value of 0 and 1 through the data on the learned data on the normal driving state or the learned data on the abnormal driving state of the first robot or the second robot.

16. The robot diagnostic system of claim 1, wherein a number of rotational axes of the first robot and the second robot is the same.

17. The robot diagnostic system of claim 16, wherein the first robot and the second robot are 6-axis robots.

18. The robot diagnostic system of claim 16, wherein each rotation axis of the first robot or the second robot is provided with a plurality of sensors configured for measuring vibrations or a current according to the driving of the first robot or the second robot.

19. A method of predicting the occurrence of abnormality in a robot, the method comprising:
simulating, by a second robot, driving of a first robot;
learning, by a model builder, data on a normal driving state or an abnormal driving state of the first robot or the second robot and building a model that is configured to determine whether the first robot is abnormal; and
receiving, by a diagnostic device, data on the driving of the first robot and diagnosing, by the diagnostic device, a state of the first robot through the built model.
